(19) United States
(12) Patent Application Publication
(10) Pub. No.: US 2025/0323458 A1
(43) Pub. Date: Oct. 16, 2025

(54) Connector and Connector Assembly

(71) Applicant: Tyco Electronics (Shanghai) Co., Ltd., Shanghai (CN)

(72) Inventors: Qi Feng, Shanghai (CN); Ziwei (Vivi) Li, Shanghai (CN); Yuchen Yang, Shanghai (CN)

(73) Assignee: Tyco Electronics (Shanghai) Co., Ltd., Shanghai (CN)

(21) Appl. No.: 19/175,077

(22) Filed: Apr. 10, 2025

(30) Foreign Application Priority Data
Apr. 12, 2024 (CN) 202410446142.4

(51) Int. Cl. H01R 13/629; H01R 13/53

(52) U.S. Cl. CPC H01R 13/629; H01R 13/53

(57) ABSTRACT

A connector includes a housing that is matable with a mating housing of a mating connector, a high-voltage module provided in the housing, the high-voltage module electrically connects and fastens to a high-voltage mating module of the mating connector, a low-voltage module movably installed outside the housing, and a locking component rotatably installed outside the housing. The locking component is limited by the high-voltage module to a locking position engaged with the low-voltage module, locking the low-voltage module in a pre installation position separated from a low-voltage mating module of the mating connector, when the high-voltage module is not fully fastened to the high-voltage mating module. The locking component rotates to an unlocking position separated from the low-voltage module, allowing the low-voltage module to move to a final installation position electrically connected to the low-voltage mating module, when the high-voltage module has been fully fastened to the high-voltage mating module.

### CROSS-REFERENCE TO RELATED APPLICATION

This application claims the benefit of the filing date under 35 U.S.C. § 119(a)-(d) of Chinese Patent Application No. 202410446142.4, filed on Apr. 12, 2024.

### FIELD OF THE INVENTION

The present invention relates to a connector and, more particularly, to a connector and a connector assembly comprising the connector.

### BACKGROUND OF THE INVENTION

A high-voltage connector typically includes a housing and high-voltage and low-voltage modules arranged within the housing. The high-voltage module is suitable for being fastened to a high-voltage mating module in a high-voltage mating connector to be electrically connected with the high-voltage mating module. The low-voltage module is used to electrically connect with a low-voltage mating module in the high-voltage mating connector. In order to prevent arcing when the high-voltage module is electrically connected to the high-voltage mating module, it is necessary to supply power to the high-voltage module and the high-voltage mating module only after the high-voltage module has been fully fastened to the high-voltage mating module.

It is usually determined whether the high-voltage module has been fully fastened to the high-voltage mating module based on the electrical connection status between the low-voltage module and the low-voltage mating module. When the low-voltage module and the low-voltage mating module are in an electrically separated state, it is determined that the high-voltage module has not been fully fastened to the high-voltage mating module. When the low-voltage module is electrically connected to the low-voltage mating module, it is determined that the high-voltage module has been fully fastened to the high-voltage mating module. The high-voltage module and low-voltage module move synchronously; during the process of fastening the high-voltage module and high-voltage mating module, the low-voltage module will also be synchronously moved to the position of electrical connection with the low-voltage mating module. It is difficult, however, to accurately determine whether the high-voltage module has been fully fastened to the high-voltage mating module based on the electrical connection status between the low-voltage module and the low-voltage mating module, which can easily lead to misjudgment and affect connector use safety.

The high-voltage module typically includes fasteners that are suitable for threaded connection with the high-voltage mating module. The fasteners fasten the high-voltage module to the high-voltage mating module to achieve electrical connection between the high-voltage module and the high-voltage mating module. Visual inspection is usually used to prevent forgetting to fully fasten the fasteners. However, it is difficult to accurately check whether the fasteners have been fully fastened visually, which can easily lead to errors and still pose a risk that the fasteners are not fully fastened. Therefore, visually inspecting whether the fasteners have been fully fastened has the problems of poor accuracy and low inspection efficiency. Moreover, failing to fully fasten the fasteners properly can lead to the failure of high-voltage connection products and even cause safety accidents.

### SUMMARY OF THE INVENTION

A connector includes a housing that is matable with a mating housing of a mating connector, a high-voltage module provided in the housing, the high-voltage module electrically connects and fastens to a high-voltage mating module of the mating connector, a low-voltage module movably installed outside the housing, and a locking component rotatably installed outside the housing. The locking component is limited by the high-voltage module to a locking position engaged with the low-voltage module, locking the low-voltage module in a pre installation position separated from a low-voltage mating module of the mating connector, when the high-voltage module is not fully fastened to the high-voltage mating module. The locking component rotates to an unlocking position separated from the low-voltage module, allowing the low-voltage module to move to a final installation position electrically connected to the low-voltage mating module, when the high-voltage module has been fully fastened to the high-voltage mating module.

### BRIEF DESCRIPTION OF DRAWINGS

The invention will now be described by way of example with reference to the accompanying figures, of which:

FIG. 1 is a perspective view of a connector assembly according to an exemplary embodiment, where a high-voltage module has not yet been fully fastened to a high-voltage mating module, a low-voltage module is in a pre installation position, and a locking component is in a locking position;

FIG. 2 is an exploded view of the connector assembly of FIG. 1;

FIG. 3 is a perspective view of a connector of the connector assembly according to an exemplary embodiment, where the low-voltage module of FIG. 1 has not yet been installed on a housing of the connector;

FIG. 4 is a longitudinal sectional view of the connector of FIG. 1, where the high voltage module of FIG. 1 has not yet been fully fastened to the high voltage mating module of FIG. 1, the low-voltage module of FIG. 1 is in the pre installation position, and the locking component of FIG. 1 is in the locking position;

FIG. 5 is a transverse sectional view of the connector assembly of FIG. 1, where the high voltage module of FIG. 1 has not yet been fully fastened to the high voltage mating module of FIG. 1, the low-voltage module of FIG. 1 is in the pre installation position, and the locking component of FIG. 1 is in the locking position;

FIG. 6 is a longitudinal sectional view of the connector assembly of FIG. 1, wherein the high voltage module of FIG. 1 has been fully fastened to the high voltage mating module of FIG. 1, the low-voltage module of FIG. 1 is in the pre installation position, and the locking component of FIG. 1 is in the locking position;

FIG. 7 is a longitudinal sectional view of the connector of FIG. 1, wherein the high voltage module of FIG. 1 has been fully fastened to the high voltage mating module of FIG. 1, the low-voltage module of FIG. 1 is in the pre installation position, and the locking component of FIG. 1 is rotated to an unlocking position;

FIG. 8 is a perspective view of the connector assembly of FIG. 1, wherein the high-voltage module of FIG. 1 has been fully fastened to the high-voltage mating module of FIG. 1, the low-voltage module of FIG. 1 is in the pre installation position, and the locking component of FIG. 1 is rotated to the unlocking position;

FIG. 9 is a perspective view of the connector assembly of FIG. 1, wherein the high-voltage module of FIG. 1 has been fully fastened to the high-voltage mating module of FIG. 1, the low-voltage module of FIG. 1 has been moved to the final installation position, and the locking component of FIG. 1 has been rotated to the unlocking position; and

FIG. 10 is a longitudinal sectional view of the connector assembly of FIG. 1, wherein the high-voltage module of FIG. 1 has been fully fastened to the high-voltage mating module of FIG. 1, the low-voltage module of FIG. 1 has been moved to the final installation position, and the locking component of FIG. 1 has been rotated to the unlocking position.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

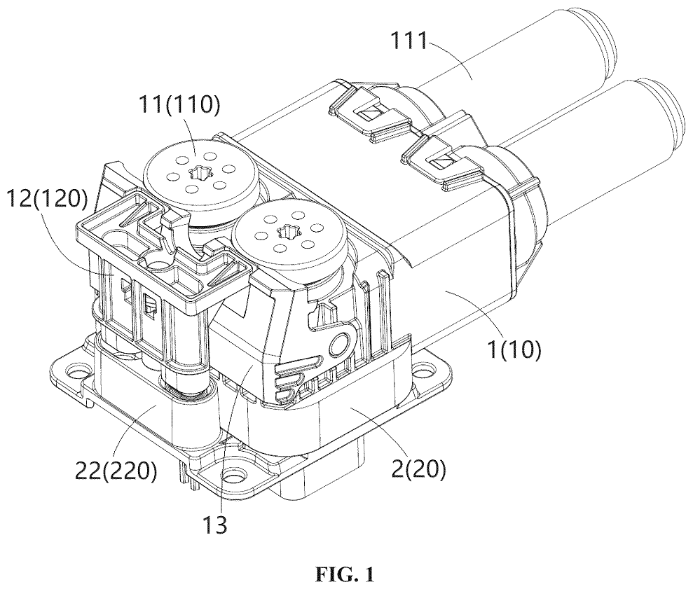

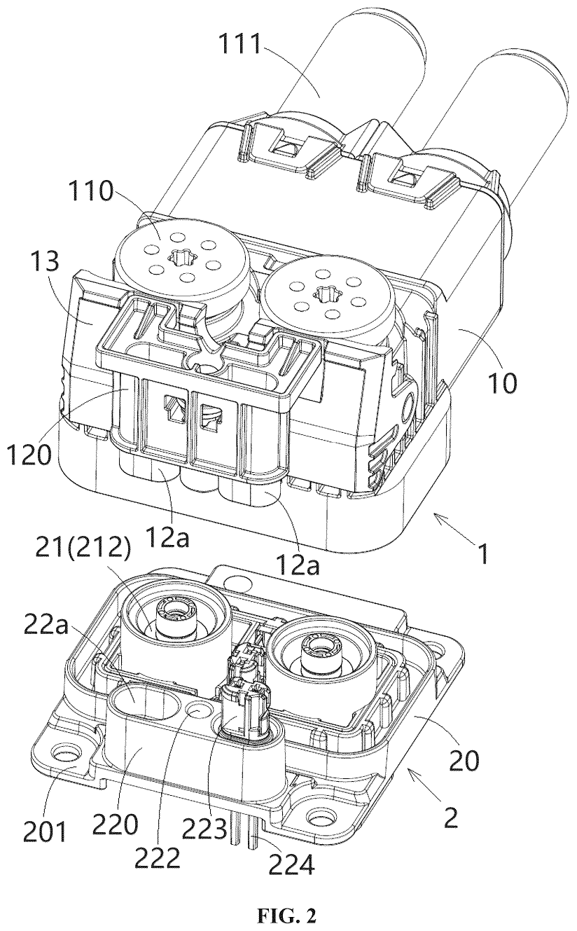

An exemplary embodiment of a connector 1 is now described with reference to FIGS. 1-10. As shown in FIGS. 1-2, the connector 1 includes a housing 10, a high-voltage module 11, a low-voltage module 12, and a locking component 13.

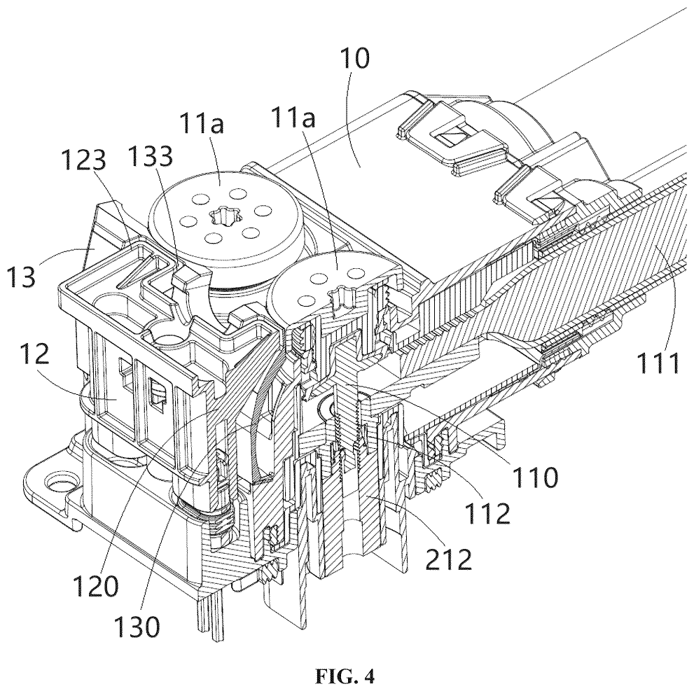

As shown in FIGS. 1-2, the housing 10 is suitable for mating with a mating housing 20 of a mating connector 2. As shown in FIGS. 4-6 and 7, the high-voltage module 11 is installed in the housing 10. The high-voltage module 11 is suitable for being fastened and electrically connected to a high-voltage mating module 21 of the mating connector 2. The low-voltage module 12 is mounted on the outside of the housing 10 in a movable manner. The locking component 13 is rotatably installed outside the housing 10.

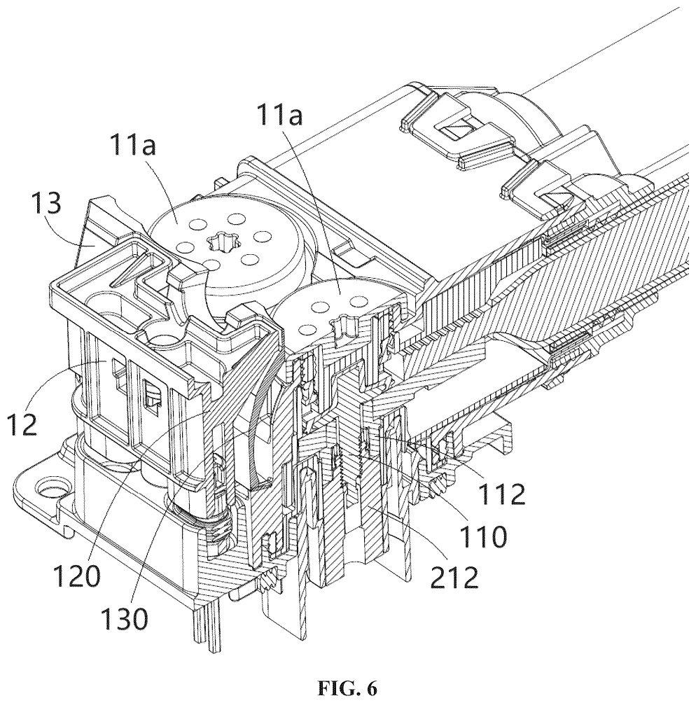

As shown in FIGS. 4-6, when the high-voltage module 11 is not fully fastened to the high-voltage mating module 21, the locking component 13 is restricted by the high-voltage module 11 to the locking position engaged with the low-voltage module 12. In the locking position, the locking component 13 locks the low-voltage module 12 in the pre installation position separated from the low-voltage mating module 22 of the mating connector 2. As shown in FIGS. 6-10, when the high-voltage module 11 has been fully fastened to the high-voltage mating module 21, the locking component 13 can be rotated to the unlocking position separated from the low-voltage module 12, allowing the low-voltage module 12 to be moved to the final installation position. In the final installation position, the low-voltage module 12 is electrically connected to the low-voltage mating module 22.

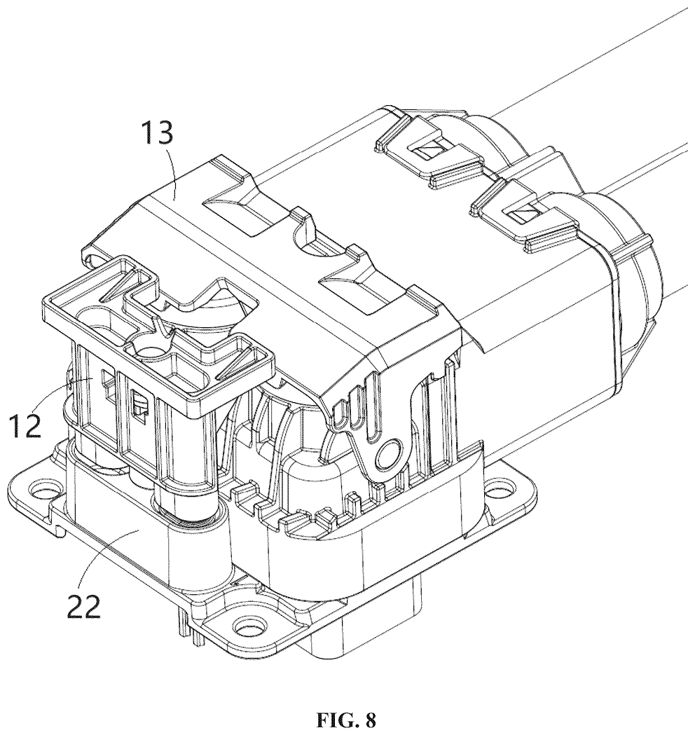

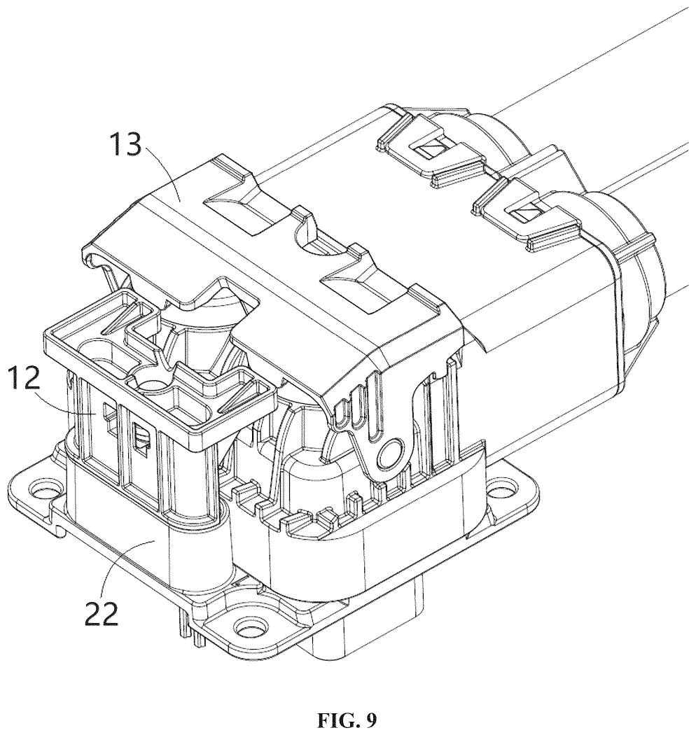

As shown in FIGS. 8-9, the low-voltage module 12 can be moved separately to the final installation position only after the high-voltage module 11 has been fully fastened to the high-voltage mating module 21. Therefore, the present invention can accurately detect or indicate whether the high-voltage module 11 has been fully fastened to the high-voltage mating module 21 based on the electrical connection status between the low-voltage module 12 and the low-voltage mating module 22, thereby effectively avoiding misjudgment and improving the safety of the connector 1.

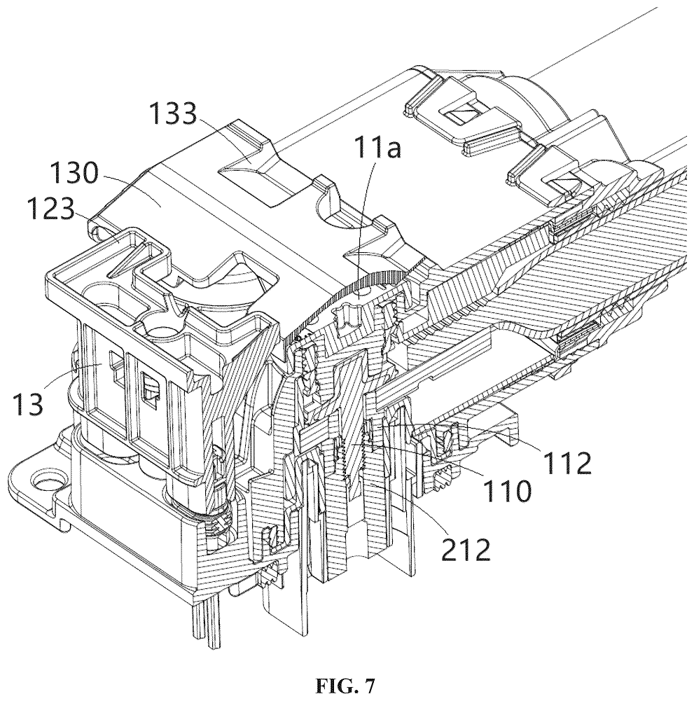

As shown in FIGS. 4-6, when the high-voltage module 11 is not fully fastened to the high-voltage mating module 21, the locking component 13 cannot be rotated from the locking position to the unlocking position. As shown in FIGS. 6-7, only when the high-voltage module 11 has been fully fastened to the high-voltage mating module 21, can the locking component 13 be rotated from the locking position to the unlocking position. Therefore, accurate checking of whether the high-voltage module 11 has been fully fastened to the high-voltage mating module 21 by the locking component 13 is achieved using the present connector 1. The connector 1 also improves the accuracy and efficiency of inspection, and effectively prevents the problem of forgetting to fully fasten the high-voltage module 11.

The locking component 13 is used to detect or indicate whether the high-voltage module 11 has been fully fastened to the high-voltage mating module 21. When the high-voltage module 11 is not fully fastened to the high-voltage mating module 21, the high-voltage module 11 is in a position that interferes with the locking component 13, so that the locking component 13 cannot be rotated from the locking position to the unlocking position. When the high-voltage module 11 has been fully fastened to the high-voltage mating module 21, the high-voltage module 11 is in a position that does not interfere with the locking component 13, allowing the locking component 13 to be rotated from the locking position to the unlocking position.

As shown in FIGS. 1-4 and 6-7, the high-voltage module 11 includes a fastener 110 suitable for threaded connection with the high-voltage mating module 21. The fastener 110 is used to fasten the high-voltage module 11 to the high-voltage mating module 21 to achieve electrical connection between the high-voltage module 11 and the high-voltage mating module 21. As shown in FIGS. 1-2 and 4-5, when the fastener 110 is not fully fastened to the high-voltage mating module 21, the outer end 11a of the fastener 110 exposed from the housing 10 is pressed against the locking component 13 to restrict the locking component 13 in the locking position, so that the locking component 13 cannot be rotated from the locking position to the unlocking position.

As shown in FIG. 6, when the fastener 110 has been fully fastened to the high-voltage mating module 21, the outer end 11a of the fastener 110 is moved to a position that does not interfere with the locking component 13, allowing the locking component 13 to be rotated from the locking position to the unlocking position. As used throughout the detailed description, “fully fastened” means that thread of the fastener 110 is completely fastened to complementary thread of the high-voltage mating terminal 212 of the high-voltage mating module 21 (see FIG. 6), and “not fully fastened” means that the thread of the fastener 110 is not completely fastened to complementary thread of the high-voltage mating terminal 212 of the high-voltage mating module 21 (see FIG. 4).

In another embodiment, when the fastener 110 is not tightened or fastened to the high-voltage mating module 21, the outer end 11a of the fastener 110 exposed from the housing 10 is pressed against the locking component 13 to restrict the locking component 13 in the locking position, so that the locking component 13 cannot be rotated from the locking position to the unlocking position. In the another embodiment, when the fastener 110 has been tightened or fastened to the high-voltage mating module 21, the outer end 11a of the fastener 110 is moved to a position that does not interfere with the locking component 13, allowing the locking component 13 to be rotated from the locking position to the unlocking position.

The high-voltage module 11 includes multiple fasteners 110, as shown in FIGS. 1-4 and 6-7, and the locking component 13 is used to simultaneously indicate or detect whether the multiple fasteners 110 have been fully fastened to the high-voltage mating module 21. When any one of the multiple fasteners 110 is not fully fastened to the high-voltage mating module 21, the locking component 13 cannot be rotated from the locking position to the unlocking position. Only when the multiple fasteners 110 have all been fully fastened to the high-voltage mating module 21 can the locking component 13 be rotated from the locking position to the unlocking position.

As shown in FIG. 6, when the fastener 110 has been fully fastened to the high-voltage mating module 21, the outer end 11a of the fastener 110 is in a position that does not interfere with the locking component 13, allowing the locking component 13 to be rotated from the locking position to the unlocking position.

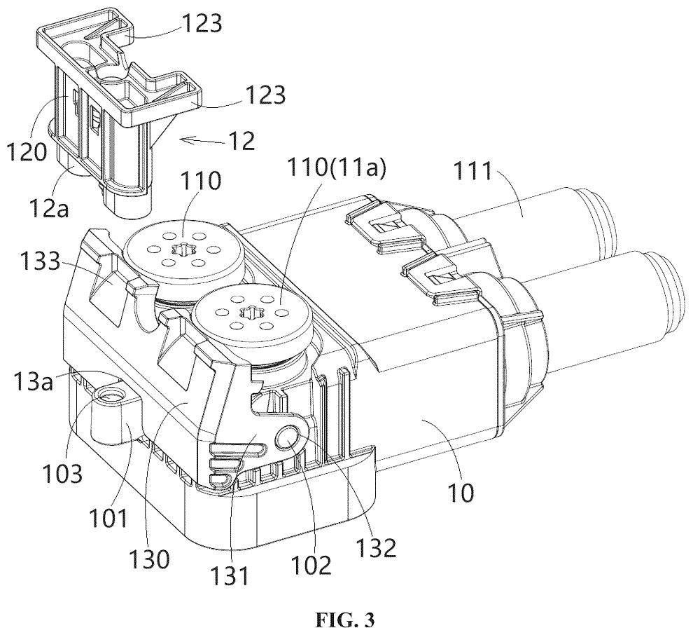

As shown in FIG. 3, the locking component 13 includes a pair of side arms 131 and a top cover 130. One end of each side arm 131 of the pair of side arms 131 are rotatably connected to both sides of the housing 10, respectively. The top cover 130 is connected between the other end of each side arm 131 of the pair of side arms 131. As shown in FIGS. 3-4, when the fastener 110 is not fully fastened to the high-voltage mating module 21, the outer end 11a of the fastener 110 rests against the top cover 130 of the locking component 13, preventing the locking component 13 from being rotated from the locking position to the unlocking position. When the fastener 110 has been fully fastened to the mating connector 2, as shown in FIG. 6, the outer end 11a of the fastener 110 does not interfere with the top cover 130 of the locking component 13, allowing the locking component 13 to rotate from the locking position to the unlocking position.

As shown in FIG. 3, pivot holes 132 are respectively formed in one end of each side arm 131 of the pair of side arms 131, and protruding pivot shafts 102 are respectively formed in both sides of the housing 10. The protruding pivot shafts 102 are rotatably engaged with the pivot holes 132, allowing the locking component 13 to rotate around the protruding pivot shafts 102.

The outer end 11a of the fastener 110 is adapted to be engaged with an operating tool. The operating tool can be used to tighten or loosen the fastener 110 through the outer end 11a. As shown in FIGS. 1-6, when the locking component 13 is in the locking position, the outer end 11a of the fastener 110 is exposed outside the top cover 130 of the locking component 13, allowing the operating tool to engage with the outer end 11a of the fastener 110 to tighten or loosen the fastener 110.

As shown in FIGS. 7-10, when the locking component 13 is rotated to the unlocking position, the outer end 11a of the fastener 110 is hidden in the top cover 130 of the locking component 13, so that the operating tool cannot engage with the outer end 11a of the fastener 110 to prevent the fully fastened fastener 110 from being accidentally loosened by the operating tool.

As shown in FIG. 4, the high-voltage module 11 further includes a high-voltage cable 111 and a high-voltage terminal 112. As shown in FIGS. 1-4, one end of the high-voltage cable 111 extends into the housing 10. The high-voltage terminal 112 is installed in the housing 10 and electrically connected to one end of the high-voltage cable 111. As shown in FIGS. 4 and 6-7, the fastener 110 is used to fasten the high-voltage terminal 112 to the high-voltage mating terminal 212 of high-voltage mating module 21, to electrically connect the high-voltage module 11 and the high-voltage mating module 21. The fastener 110 is suitable for being threaded to the high-voltage mating terminal 212 or a nut inside the mating connector 2 to fasten the high-voltage terminal 112 and the high-voltage mating terminal 212 together.

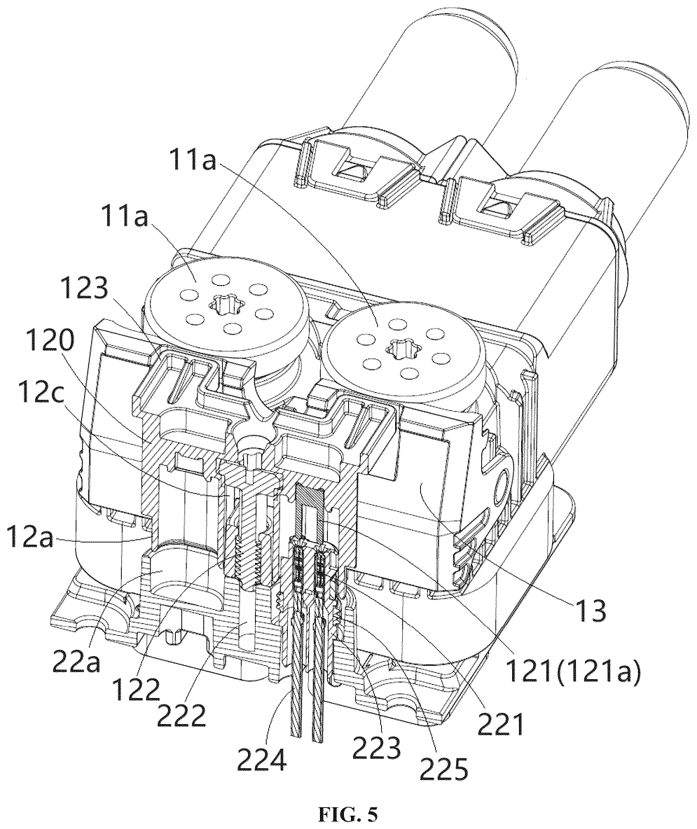

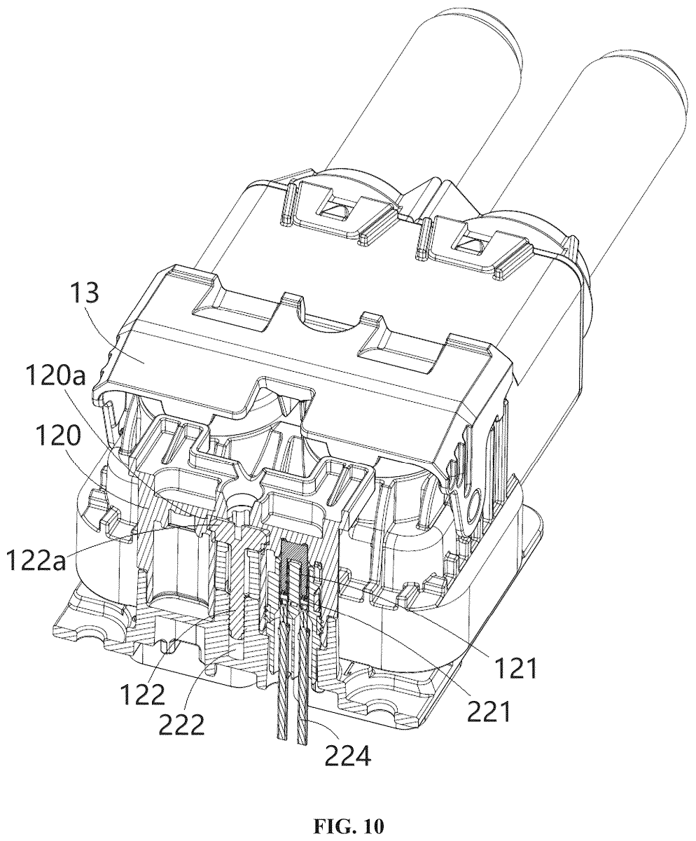

As shown in FIGS. 5 and 10, the low-voltage module 12 includes a movable shell 120 and a low-voltage terminal 121. The movable shell 120 is installed on the outside of the housing 10 in a movable manner, and can be moved between the pre installation position (as shown in FIG. 5) and the final installation position (as shown in FIG. 10). The low-voltage terminal 121 is fixed to the movable shell 120 and is suitable for mating with the low-voltage mating terminal 221 of the low-voltage mating module 22. As shown in FIG. 10, when the movable shell 120 is moved to the final installation position, the low-voltage terminal 121 is mated with the low-voltage mating terminal 221 to electrically connect the low-voltage module 12 and the low-voltage mating module 22.

As shown in FIGS. 3-4 and 7, a first joint part 123 is formed on the movable shell 120, and a second joint part 133 suitable for engagement with the first joint part 123 is formed on the locking component 13. As shown in FIGS. 3-4, when the movable shell 120 is in the pre installation position and the locking component 13 is in the locking position, the first joint part 123 is engaged with the second joint part 133 to lock the movable shell 120 in the pre installation position. As shown in FIG. 7, when the locking component 13 is rotated to the unlocking position, the first joint part 123 is separated from the second joint part 133 to allow the movable shell 120 to be moved from the pre installation position to the final installation position. In the illustrated embodiment, the first joint part 123 is a protruding tongue, and the second joint part 133 is a concave part suitable for engaging with the protruding tongue.

As shown in FIGS. 5 and 10, the low-voltage module 12 further includes a connecting bolt 122, which is rotatably connected to the movable shell 120 and can be rotated relative to the movable shell 120. The connecting bolt 122 is used for threaded connection with the threaded hole 222 in the fixed shell 220 of the low-voltage mating module 22, to drive the movable shell 120 from the pre installation position to the final installation position and lock the movable shell 120 in the final installation position.

As shown in FIG. 10, the connecting bolt 122 has a flange part 122a located at its head, and a slot 120a is formed in the movable shell 120. The flange part 122a of the connecting bolt 122 is rotatably engaged in the slot 120a, so that the connecting bolt 122 can be rotated around its axis and cannot be separated from the movable shell 120 in its axial direction.

As shown in FIGS. 2-3 and 5, the movable shell 120 includes a pair of cylindrical parts 12a, which are adapted to be respectively inserted into a pair of insertion holes 22a in the fixed shell 220 for positioning the movable shell 120 onto the fixed shell 220.

As shown in FIG. 5, a guide slot 12c is defined between the pair of cylindrical parts 12a. As shown in FIG. 3, a guide wall 101 is formed on the outside of the housing 10. The guide wall 101 is mated with the guide slot 12c to guide the movable shell 120 to move along the axial direction of the connecting bolt 122. As shown in FIG. 3, when the locking component 13 is in the locking position, the guide wall 101 engages with a groove 13a on the locking component 13 to hold the locking component 13 in the locking position.

As shown in FIG. 3, a through hole 103 is formed in the guide wall 101. The through hole 103 allows the connecting bolt 122 to pass through. The connecting bolt 122 passes through the through hole 103 in the guide wall 101.

As shown in FIG. 5, the low-voltage terminal 121 is provided in one cylindrical part 12a of the movable shell 120, suitable for mating with a low-voltage mating terminal 221 inserted into the one cylindrical part 12a.

An exemplary embodiment of a connector assembly is now described with reference to FIGS. 1-10. The connector assembly includes the connector 1 according to FIGS. 1-10 and the mating connector 2 according to FIGS. 1-2, and 4-10. The mating connector 2 is mated with the connector 1.

As shown in FIGS. 1-2, the mating connector 2 includes a mating housing 20, a high-voltage mating module 21, and a low-voltage mating module 22. The mating housing 20 is mated with the housing 10 of the connector 1. The high-voltage mating module 21 is installed in the mating housing 20 for electrical connection to the high-voltage module 11 of the connector 1. The low-voltage mating module 22, as shown in FIGS. 1 and 8-9, is fixedly installed outside the mating housing 20 for electrical connection to the low-voltage module 12 of the connector 1.

The low-voltage mating module 22 includes a fixed shell 220, as shown in FIGS. 1-2, an insulation retaining body 223, as shown in FIGS. 2 and 5, and a low-voltage mating terminal 221, as shown in FIGS. 5 and 10. The fixed shell 220 is integrally formed with the mating housing 20 or fixed to the outside of the mating housing 20. The insulation retaining body 223 is fixedly installed in the fixed shell 220. The low-voltage mating terminal 221 is fixedly installed in the insulation retaining body 223. The low-voltage mating terminal 221 is used to mate with the low-voltage terminal 121 of the low-voltage module 12, to electrically connect the low-voltage module 12 and the low-voltage mating module 22.

As shown in FIGS. 2, 5, and 10, a threaded hole 222 is formed in the fixed shell 220 of the low-voltage mating module 22. The threaded hole 222 is used for threaded connection with the connecting bolt 122 of the low-voltage module 12.

As shown in FIGS. 2 and 5, a pair of insertion holes 22a are formed in the fixed shell 220 of the low-voltage mating module 22. The pair of cylindrical parts 12a on the movable shell 120 of the low-voltage module 12 are suitable for being respectively inserted into the pair of insertion holes 22a for positioning the movable shell 120 onto the fixed shell 220.

As shown in FIG. 2, the threaded hole 222 in the fixed shell 220 is located between the pair of insertion holes 22a, and the insulation retaining body 223 is inserted into one of the insertion holes 22a of the fixed shell 220. As shown in FIG. 5, each insulation retaining body 223 and each low-voltage mating terminal 221 are suitable for insertion into one cylindrical part 12a of the movable shell 120 to mate with one low-voltage terminal 121 in the one cylindrical part 12a.

As shown in FIG. 5, the low-voltage mating module 22 further includes a sealing ring 225, which is fitted on the insulation retaining body 223. The sealing ring 225 is adapted to be radially compressed between the insulation retaining body 223 and the inner wall of one cylindrical part 12a of the movable shell 120 to achieve sealing between the two.

As shown in FIGS. 2, 5, and 10, the low-voltage mating module 22 further includes a low-voltage cable 224, which is connected to the low-voltage mating terminal 221 and led out from the fixed shell 220 for electrical connection to a low-voltage detection circuit. The low-voltage mating module 22 includes two low-voltage mating terminals 221 and two low-voltage cables 224. One end of each low-voltage cable 224 of the two low-voltage cables 224 are respectively connected to the two low-voltage mating terminals 221. The low-voltage terminal 121 of the low-voltage module 12 includes two pins 121a, shown in FIG. 5, which are suitable for respectively plugging into two low-voltage mating terminals 221 to electrically connect the two low-voltage mating terminals 221.

As shown in FIG. 2, the mating housing 20 includes a flange 201 located on its exterior, which is used for mounting or other installation onto an installation panel. The fixed shell 220 of the low-voltage mating module 22 is integrally formed on or fixed to the flange 201.

As shown in FIGS. 2, 4, and 6-7, the high-voltage mating module 21 includes a high-voltage mating terminal 212, and a threaded connection hole is formed in the high-voltage mating terminal 212. As shown in FIGS. 4 and 6-7, the fastener 110 passes through one end of the high-voltage cable 111 and the high-voltage terminal 112 and is threaded into the threaded connection hole of the high-voltage mating terminal 212 to fasten the high-voltage terminal 112 and the high-voltage mating terminal 212 together.

However, the present invention is not limited to the illustrated embodiment. For example, in another exemplary embodiment of the present invention, the high-voltage mating module 21 includes a high-voltage mating terminal 212 and a nut fixed to the high-voltage mating terminal 212. In the another exemplary embodiment, the fastener 110 passes through one end of the high-voltage cable 111, the high-voltage terminal 112, and the high-voltage mating terminal 212 and is threaded with the nut to fasten the high-voltage terminal 112 and the high-voltage mating terminal 212 together.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A connector, comprising:
a housing that is matable with a mating housing of a mating connector;
a high-voltage module provided in the housing, the high-voltage module electrically connects and fastens to a high-voltage mating module of the mating connector;
a low-voltage module movably installed outside the housing; and
a locking component rotatably installed outside the housing, the locking component is limited by the high-voltage module to a locking position engaged with the low-voltage module, locking the low-voltage module in a pre installation position separated from a low-voltage mating module of the mating connector, when the high-voltage module is not fully fastened to the high-voltage mating module, the locking component rotates to an unlocking position separated from the low-voltage module, allowing the low-voltage module to move to a final installation position electrically connected to the low-voltage mating module, when the high-voltage module has been fully fastened to the high-voltage mating module.

2. The connector of claim 1, wherein the locking component indicates whether the high-voltage module has been fully fastened to the high-voltage mating module, when the high-voltage module is not fully fastened to the high-voltage mating module, the high-voltage module interferes with the locking component preventing the locking component from rotating from the locking position to the unlocking position, and when the high-voltage module has been fully fastened to the high-voltage mating module, the high-voltage module does not interfere with the locking component, allowing the locking component to rotate from the locking position to the unlocking position.

3. The connector of claim 2, wherein the high-voltage module has a fastener fastening the high-voltage module to the high-voltage mating module to achieve electrical connection between the high-voltage module and the high-voltage mating module, when the fastener is not fully fastened to the high-voltage mating module, an outer end of the fastener exposed from the housing is pressed against the locking component to restrict the locking component in the locking position, and when the fastener has been fully fastened to the high-voltage mating module, the outer end of the fastener does not interfere with the locking component, allowing the locking component to be rotated from the locking position to the unlocking position.

4. The connector of claim 3, wherein the fastener is one of a plurality of fasteners, and the locking component simultaneously indicates whether all of the fasteners have been fully fastened to the high-voltage mating module, the locking component cannot be rotated from the locking position to the unlocking position when at least one fastener is not fully fastened to the high-voltage mating module, and the locking component can be rotated from the locking position to the unlocking position when all of the fasteners have been fully fastened to the high-voltage mating module.

5. The connector of claim 3, wherein when the fastener has been fully fastened to the high-voltage mating module, the outer end of the fastener is in a position that does not interfere with the locking component, allowing the locking component to rotate from the locking position to the unlocking position.

6. The connector of claim 5, wherein the locking component has a pair of side arms and a top cover, one end of each side arm is rotatably connected to one side of the housing, the top cover is connected between another end of each side arm, when the fastener is not fully fastened to the high-voltage mating module, the outer end of the fastener rests against the top cover of the locking component, preventing the locking component from rotating from the locking position to the unlocking position, and when the fastener has been fully fastened to the mating connector, the outer end of the fastener does not interfere with the top cover of the locking component, allowing the locking component to rotate from the locking position to the unlocking position.

7. The connector of claim 6, wherein the outer end of the fastener engages with an operating tool tightening or loosening the fastener, and when the locking component is in the locking position, the outer end of the fastener is exposed outside the top cover of the locking component, allowing the operating tool to engage with the outer end of the fastener to tighten or loosen the fastener, and when the locking component is rotated to the unlocking position, the outer end of the fastener is hidden in the top cover of the locking component, preventing the operating tool from engaging with the outer end of the fastener.

8. The connector of claim 4, wherein the high-voltage module has a high-voltage cable and a high-voltage terminal, one end of the high-voltage cable extends into the housing, the high-voltage terminal is provided in the housing and electrically connects to the one end of the high-voltage cable, the fastener fastens the high-voltage terminal to a high-voltage mating terminal of the high-voltage mating module to electrically connect the high-voltage module and the high-voltage mating module.

9. The connector of claim 1, wherein the low-voltage module has a movable shell and a low-voltage terminal, the movable shell is installed outside the housing and moves between the pre installation position and the final installation position, the low-voltage terminal is fixed to the movable shell and is matable with a low-voltage mating terminal of the low-voltage mating module, and when the movable shell is moved to the final installation position, the low-voltage terminal is mated with the low-voltage mating terminal to electrically connect the low-voltage module and the low-voltage mating module.

10. The connector of claim 9, wherein a first joint part is formed on the movable shell and a second joint part engaging the first joint part is formed on the locking component, the first joint part is engaged with the second joint part to lock the movable shell in the pre installation position when the movable shell is in the pre installation position and the locking component is in the locking position, and the first joint part is separated from the second joint part to allow the movable shell to move from the pre installation position to the final installation position when the locking component is rotated to the unlocking position.

11. The connector of claim 9, wherein the low-voltage module has a connecting bolt rotatably connected to the movable shell and rotatable relative to the movable shell, the connecting bolt is threadably connected with a threaded hole in a fixed shell of the low-voltage mating module to drive the movable shell to move from the pre installation position to the final installation position and lock the movable shell in the final installation position, the connecting bolt has a head and a flange part located at the head, and a slot is formed in the movable shell, the flange part of the connecting bolt is rotatably engaged in the slot, so that the connecting bolt can be rotated around an axis of the connecting bolt and cannot be separated from the movable shell in an axial direction of the connecting bolt.

12. The connector of claim 11, wherein the movable shell has a pair of cylindrical parts each inserted into one insertion hole of a pair of insertion holes in the fixed shell for positioning the movable shell onto the fixed shell, a guide slot is defined between the pair of cylindrical parts, and a guide wall is formed on the outside of the housing, the guide wall is mated with the guide slot to guide the movable shell to move along the axial direction of the connecting bolt, the guide wall engages with a groove on the locking component to hold the locking component in the locking position when the locking component is in the locking position.

13. The connector of claim 12, wherein the low-voltage terminal is provided in one cylindrical part of the movable shell, the low-voltage terminal mates with the low-voltage mating terminal inserted into the one cylindrical part.

14. A connector assembly, comprising:
a connector including a housing, a high-voltage module, a low-voltage module, and a locking component, the high-voltage module is provided in the housing, the low-voltage module is movably installed outside the housing, and the locking component is rotatably installed outside the housing; and
a mating connector mated with the connector, the mating connector includes a mating housing, a high-voltage mating module, and a low-voltage mating module, the mating housing mates with the housing of the connector, the high-voltage mating module is provided in the mating housing, the high-voltage mating module electrically connects to the high-voltage module of the connector, and the low-voltage mating module is fixedly provided outside the mating housing, the low-voltage mating module electrically connects to the low-voltage module of the connector, the locking component is limited by the high-voltage module to a locking position engaged with the low-voltage module, locking the low-voltage module in a pre installation position separated from the low-voltage mating module of the mating connector, when the high-voltage module is not fully fastened to the high-voltage mating module, and when the high-voltage module has been fully fastened to the high-voltage mating module, the locking component rotates to an unlocking position separated from the low-voltage module, allowing the low-voltage module to move to a final installation position electrically connected to the low-voltage mating module.

15. The connector assembly of claim 14, wherein the low-voltage mating module has a fixed shell integrally formed with the mating housing or fixed to an outside of the mating housing, an insulation retaining body fixedly installed in the fixed shell, and a low-voltage mating terminal fixedly provided in the insulation retaining body, the low-voltage mating terminal mates with a low-voltage terminal of the low-voltage module to electrically connect the low-voltage module and the low-voltage mating module, a connecting bolt of the low-voltage module threadably connects to a threaded hole formed in the fixed shell of the low-voltage mating module.

16. The connector assembly of claim 15, wherein a movable shell of the low-voltage module has a pair of cylindrical parts each inserted into one insertion hole of a pair of insertion holes in the fixed shell for positioning the movable shell onto the fixed shell, the threaded hole in the fixed shell is located between the pair of insertion holes, and the insulation retaining body is inserted into one insertion hole, the insulation retaining body and the low-voltage mating terminal are inserted into one cylindrical part of the movable shell to mate with the low-voltage terminal in the one cylindrical part.

17. The connector assembly of claim 16, wherein the low-voltage mating module has
a sealing ring fitted onto the insulation retaining body, the sealing ring is radially compressed between the insulation retaining body and an inner wall of the one cylindrical part of the movable shell and seals between the insulation retaining body and the inner wall of the one cylindrical part.

18. The connector assembly of claim 17, wherein the low-voltage mating module has two low-voltage mating terminals and two low-voltage cables, one end of each of the two low-voltage cables is connected to one of the two low-voltage mating terminals, the low-voltage terminal has two pins each plugged into one of the two low-voltage mating terminals, the two pins electrically connect the two low-voltage mating terminals.

19. The connector assembly of claim 14, wherein the high-voltage mating module has a high-voltage mating terminal, a threaded connection hole is formed on the high-voltage mating terminal, and the high-voltage module has a fastener, a high-voltage cable, and a high-voltage terminal, the fastener passes through one end of the high-voltage cable and the high-voltage terminal and is threaded into the threaded connection hole of the high-voltage mating terminal to fasten the high-voltage terminal and the high-voltage mating terminal together.

20. The connector assembly of claim 14, wherein the high-voltage mating module has a high-voltage mating terminal and a nut fixed to the high-voltage mating terminal, and the high-voltage module has a fastener, a high-voltage cable, and a high-voltage terminal, the fastener passes through one end of the high-voltage cable, the high-voltage terminal, and the high-voltage mating terminal and is threaded with the nut to fasten the high-voltage terminal and the high-voltage mating terminal together.
